(19) United States
(12) Patent Application Publication
(10) Pub. No.: US 2026/0326453 A1
(43) Pub. Date: Oct. 22, 2026

(54) INK PRESSURE REGULATING DEVICE, PRINTING MACHINE COMPRISING AT LEAST ONE SUCH PRESSURE REGULATING DEVICE

(71) Applicants: Airbus SAS, BLAGNAC (FR); Airbus Operations SAS, TOULOUSE (FR)

(72) Inventors: Boris MORINIERE, ROCHEFORT (FR); Olivier BÜRGY, TOULOUSE (FR)

(21) Appl. No.: 19/468,081

(22) Filed: Feb. 3, 2026

(30) Foreign Application Priority Data
Feb. 12, 2025 (FR) FR2501451

(51) Int. Cl. B41J 2/175; B41J 2/20

(52) U.S. Cl. CPC B41J 2/17596; B41J 2/20

(57) ABSTRACT

An ink pressure regulating device for a printing machine with a rigid casing, a flexible membrane connected to the casing in a sealed manner in order to delimit a first cavity, partition which is located in the first cavity and which is configured to generate in the first cavity a flow path connecting inlet and outlet orifices of the first cavity. The membrane may occupy a first state in which the membrane is at a distance from the partition and a second state in which the membrane is in contact with the partition so as to form the flow path. A control system is provided to control the state of the membrane.

### CROSS-REFERENCES TO RELATED APPLICATIONS

This application claims the benefit of French Patent Application Number FR2501451 filed on Feb. 12, 2025, the entire disclosure of which is incorporated herein by way of reference.

### FIELD OF THE INVENTION

The present application relates to an ink pressure regulating device and a printing machine comprising at least one such pressure regulating device.

### BACKGROUND OF THE INVENTION

According to one embodiment of the prior art, an ink printing machine comprises at least one ink reservoir, at least one printing head which is configured to transfer the ink to a substrate and at least one ink distribution system connecting an ink reservoir and a printing head. This distribution system comprises pipes, pumps and at least one ink pressure regulating device which is configured to regulate and/or stabilize the pressure of the ink. Thus this regulating device not only makes it possible to adjust the pressure of the ink to at least a given pressure value but also to reduce the variations in pressure of the ink generated by the pumps and/or the printing heads, for example.

According to one embodiment of the prior art which can be seen in FIG. 1, a pressure regulating device 10 comprises an enclosure 12, a deformable membrane 14 which is positioned in the enclosure 12, dividing it into a first cavity 16 located below the membrane 14 and a second cavity 18 located above the membrane 14, an ink inlet 20 opening into the first cavity 16 and connected to an ink reservoir and an ink outlet 22 opening into the first cavity 16 and connected to a printing head.

During operation, the first and second cavities 16, 18 are respectively filled with ink and a gas, the membrane 14 separating the ink and the gas. Since the ink is in contact with the membrane 14, a variation in the pressure of the ink tends to cause a displacement of the membrane 14 in the vertical direction. Since the gas present in the second cavity 18 is compressible, it tends to damp the variations in pressure of the ink. Moreover, by regulating the pressure of the gas which is present in the second cavity 18, it is possible to regulate the pressure of the ink which passes through in the first cavity 16 of the pressure regulating device.

In order to obtain an effective damping effect, the membrane 14 has to have the largest possible dimension, which results in a significant volume of the first cavity 16. In this case, as illustrated in FIG. 1, the pressure regulating device 10 is difficult to clean during a change of ink since some areas of the first cavity 16 are not accessible and form dead areas.

### SUMMARY OF THE INVENTION

The present invention aims to remedy all or some of the drawbacks of the prior art.

To this end, a subject of the invention is an ink pressure regulating device for a printing machine, said device comprising at least one rigid casing, at least one flexible membrane which is connected to the casing in a sealed manner in order to delimit a first cavity, at least one inlet orifice which is configured to permit an ink to penetrate into the first cavity and at least one outlet orifice which is configured to permit the ink to exit from the first cavity.

According to the invention, the pressure regulating device comprises at least one partition which is located in the first cavity and which is configured to generate in the first cavity at least one flow path connecting the inlet and outlet orifices. In addition, the membrane is configured to occupy a first state in which the membrane is at a distance from said at least one partition and a second state in which the membrane is in contact with said at least one partition so as to form the flow path, the pressure regulating device comprising at least one control system which is configured to control the state of the membrane.

When the membrane is in the second state, it is in contact with the partition (or the partitions) and delimits therewith at least one flow path of small cross section between the inlet and outlet orifices, guaranteeing an optimal cleaning of the first cavity by preventing the formation of dead areas in the first cavity.

According to a further optional feature, the casing comprises at least one bottom wall and at least one cylindrical lateral wall which is connected to the bottom wall and which has a free edge at a distance from the bottom wall, the membrane being connected thereto in a sealed manner.

In addition, the partition is a spiral-shaped partition which is connected to the bottom wall and which delimits a spiral-shaped flow path connecting the inlet and outlet orifices.

According to a further optional feature, a first orifice, from the inlet and outlet orifices, adjoins the lateral wall, a second orifice which is different from the first orifice, from the inlet and outlet orifices, being located substantially in the center of the bottom wall.

According to a further optional feature, the pressure regulating device comprises at least one temperature regulating system which is configured to regulate the temperature of the ink which is present in the first cavity.

According to a further optional feature, the bottom wall has an internal face which is oriented toward the first cavity and an external face opposing the internal face. In addition, the temperature regulating system comprises at least one heating plate which is placed against the external face of the bottom wall, this bottom wall being produced from thermally conductive material.

According to a further optional feature, the pressure regulating device comprises a cover which is connected to the casing so as to delimit with the membrane a second cavity.

According to a further optional feature, the control system comprises at least one system for controlling the pressure of a gas present in the second cavity and which is configured to adjust the pressure of the gas in the second cavity to a value of less than or equal to a first threshold corresponding to the first state of the membrane or to a value of greater than or equal to a second threshold corresponding to the second state of the membrane, the first threshold being less than or equal to the second threshold.

According to a further optional feature, the pressure regulating device comprises at least one pressure sensor which is configured to measure the pressure of the gas which is present in the second cavity.

According to a further optional feature, the pressure regulating device comprises at least one position sensor which is configured to determine the position of the membrane.

A further subject of the invention is a printing machine comprising at least one ink reservoir, at least one printing head and at least one ink distribution system connecting the ink reservoir and the printing head, which comprises at least one ink pressure regulating device according to one of the above features.

According to a further feature, the ink distribution system comprises at least one pair of first and second pressure regulating devices.

According to a further feature, the ink distribution system comprises:
a substrate which comprises first and second opposing faces respectively having first and second recesses,
a first cover which is placed against the first face of the substrate and which is connected thereto so as to capture the casing and the membrane of the first pressure regulating device in the first recess,
a second cover which is placed against the second face of the substrate and which is connected thereto so as to capture the casing and the membrane of the second pressure regulating device in the second recess.

### BRIEF DESCRIPTION OF THE DRAWINGS

Further features and advantages will be found in the following description of the invention, the description being provided solely by way of example, with reference to the accompanying drawings, in which:

FIG. 1 is a schematic cross section of an ink pressure regulating device illustrating an embodiment of the prior art;

FIG. 2 is a cross section of an ink pressure regulating device illustrating an embodiment of the invention in a first state;

FIG. 3 is a cross section of the ink pressure regulating device which can be seen in FIG. 2 in a second state;

FIG. 4 is a cross section of an ink pressure regulating device illustrating a further embodiment of the invention;

FIG. 5 is a perspective view of a casing of an ink pressure regulating device illustrating an embodiment of the invention; and,

FIG. 6 is a perspective view of a printing machine which comprises the ink pressure regulating device which can be seen in FIG. 4, illustrating an embodiment of the invention.

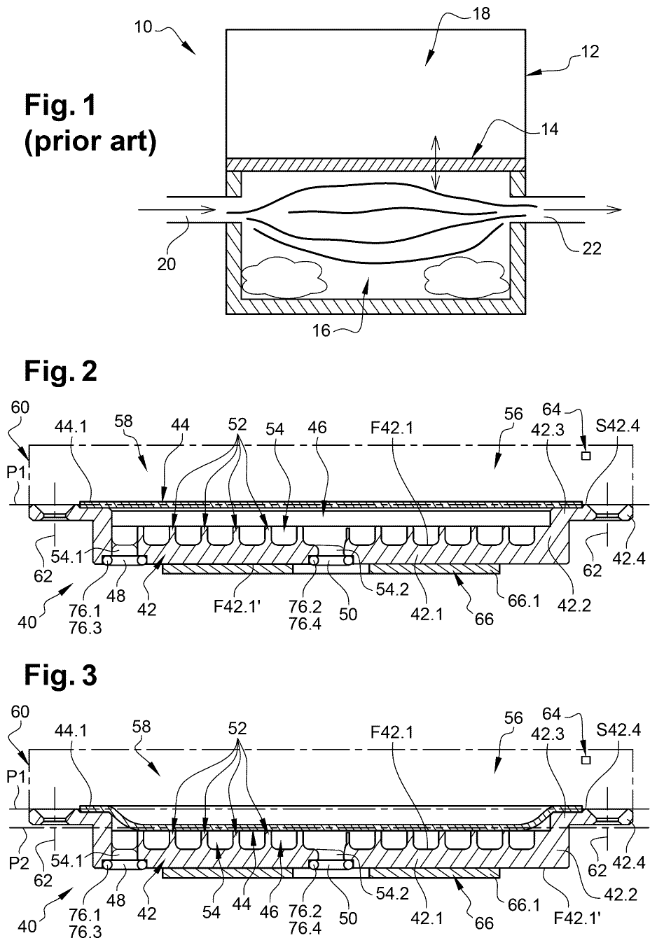

### DETAILED DESCRIPTION OF THE PREFERRED EMBODIMENTS

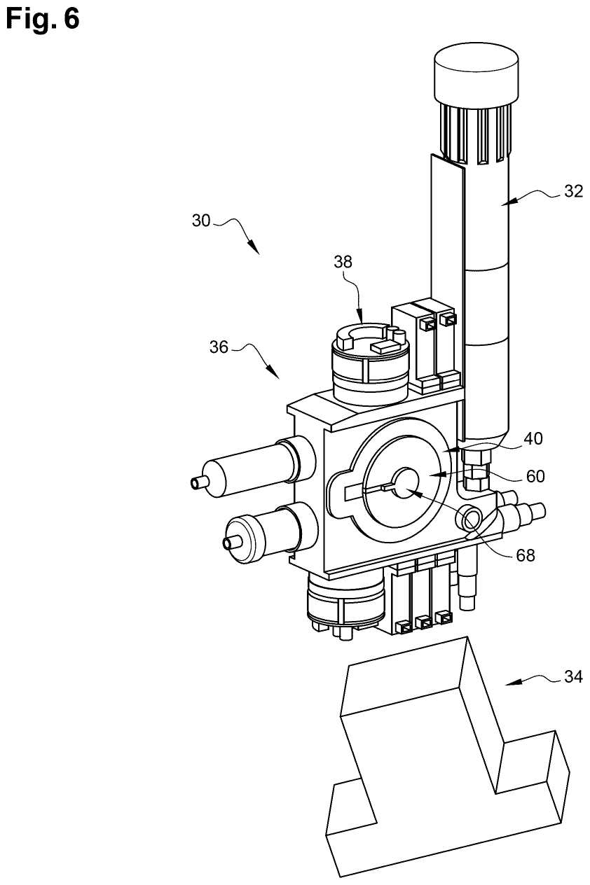

According to an embodiment which can be seen in FIG. 6, an ink printing machine 30 comprises at least one ink reservoir 32, at least one printing head 34 which is configured to transfer the ink to a substrate and at least one ink distribution system 36 connecting an ink reservoir and a printing head. This ink distribution system 36 comprises, amongst other things, pipes, at least one pump 38 and at least one ink pressure regulating device 40 which is configured to regulate and/or stabilize the pressure of the ink. Thus this pressure regulating device 40 makes it possible not only to adjust the pressure of the ink to at least a given pressure value but also to reduce the variations in pressure of the ink generated, in particular, by the pump 38 and/or the printing head 34.

With the exception of the pressure regulating device 40, the other elements of the ink printing machine 30 are not described further since they may be identical to those of the printing systems of the prior art.

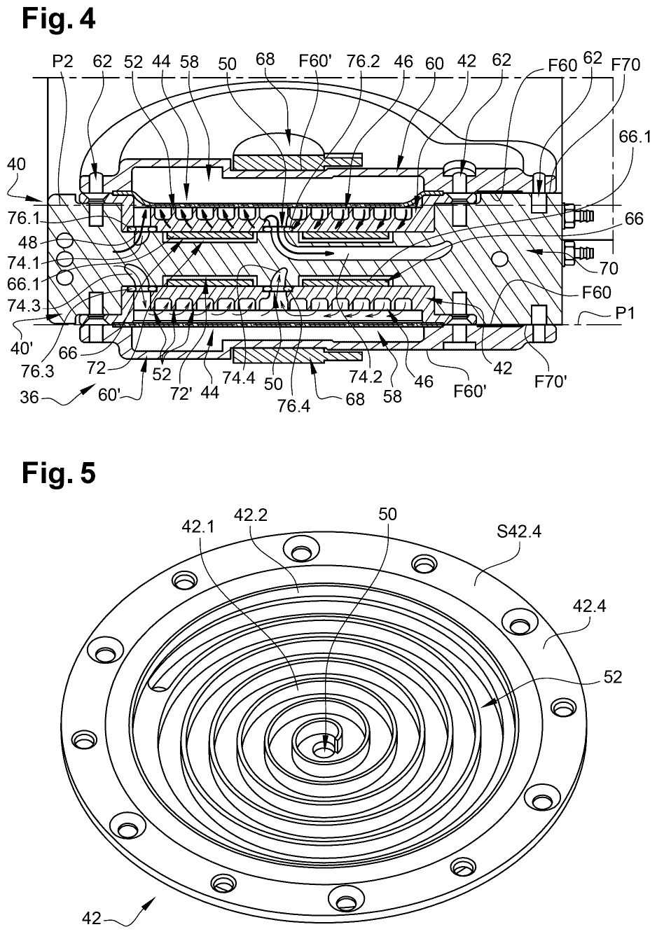

According to one embodiment which can be seen in FIGS. 2 and 4, the pressure regulating device 40 comprises:
at least one rigid casing 42,
at least one flexible membrane 44 which is connected to the casing 42 in a sealed manner so as to delimit a first cavity 46,
at least one inlet orifice 48 which is configured to permit an ink to penetrate into the first cavity 46,
at least one outlet orifice 50 which is configured to permit the ink to exit from the first cavity 46.

During operation, the inlet orifice 48 is connected to at least one ink reservoir 32 (which can be seen in FIG. 6) and the outlet orifice 50 is connected to at least one printing head 34.

The membrane 44 is configured to be deformed in a resilient manner. By way of example, the membrane 44 is made of elastomer. The membrane 44 is not described further since it may be identical to those of the regulating devices of the prior art.

Whatever the embodiment, the membrane 44 is configured to occupy a first state, which can be seen in FIG. 2, in which the membrane 44 is not deformed, is substantially (i.e., +/−10%) planar and located in a first plane P1 and a second state, which can be seen in FIG. 3, in which the membrane 44 is deformed and partially positioned in a second plane P2 offset toward the inside of the first cavity 46.

According to one embodiment, the casing 42 comprises at least one bottom wall 42.1 and at least one lateral wall 42.2 which is connected to the bottom wall 42.1 and substantially perpendicular thereto. The bottom wall 42.1 and the lateral wall 42.2 form a single part in one piece. The lateral wall 42.2 has a free edge 42.3 at a distance from the bottom wall 42.1, the membrane 44 being connected thereto in a sealed manner. According to one configuration, the casing 42 comprises a flange 42.4 which is connected to the free edge 42.3 of the lateral wall 42.2 and is substantially perpendicular thereto. This flange 42.4 has a planar contact surface S42.4 which is substantially parallel to the bottom wall 42.1. The membrane 44 comprises a peripheral edge 44.1 which is placed against at least one part of the contact surface S42.4 of the flange 42.4 and is connected thereto. The contact surface S42.4 is substantially coplanar with the first plane P1, the second plane P2 being offset toward the bottom wall 42.1 relative to the first plane P1.

The bottom wall 42.1 has an internal face F42.1 oriented toward the first cavity 46 and an external face F42.1′ opposing the internal face F42.1.

According to one arrangement, the lateral wall 42.2 is cylindrical and the flange 42.4 is a ring.

According to a particularity of the invention, the pressure regulating device 40 comprises at least one partition 52 which is located in the first cavity 46 and which is configured to generate in the first cavity 46 at least one flow path 54 connecting the inlet and outlet orifices 48, 50 when the membrane 44 is in the second state. The partition 52 is connected to the casing 42, more particularly to the bottom wall 42.1, and is dimensioned so as to be at a distance from the membrane 44 when it is in the first state (non-deformed) and in contact with the membrane 44 when it is in the second state (deformed). Each partition 52 is provided in the region of the internal face F42.1 of the bottom wall 42.1 and protrudes relative to said internal face F42.1.

According to one configuration, the pressure regulating device 40 comprises at least one spiral-shaped partition 52 which is centered relative to the lateral wall 42.2 of the casing 42, delimiting a spiral-shaped flow path 54 extending between first and second ends 54.1, 54.2; a first orifice, from the inlet and outlet orifices 48, 50, being located in the region of the first end 54.1 of the flow path 54 and adjoining the lateral wall 42.2, a second orifice which is different from the first orifice, from the inlet and outlet orifices 48, 50, being located in the region of the second end 54.2 of the flow path 54 and substantially in the center of the bottom wall 42.1. The spiral-shaped wall 52 is connected to the bottom wall 42.1 of the casing 42. It is preferably substantially perpendicular thereto.

In order to provide an order of magnitude, the bottom wall 42.1, the lateral wall 42.2 and the spiral-shaped partition 52 delimit a first cavity 46 which has a volume in the order of 20 ml when the membrane 44 is in the first state. When the flow rate of the ink entering the first cavity 46 is between 150 and 200 ml/min, the ink remains in the first cavity 46 for a period of between 3 and 6 s.

Naturally, the invention is not limited to this configuration for the partition. Thus the pressure regulating device 40 could comprise a plurality of partitions 52 delimiting a serpentine flow path 54.

Whatever the embodiment, when the membrane 44 is in the first state it is separated from the partition (or the partitions) 52 and can oscillate on either side of the first plane P1 so as to permit a regulation of the pressure of the ink, including a damping of the variations in the pressure of the ink. When the membrane 44 is in the second state, it is in contact with the partition (or the partitions) 52 and delimits therewith at least one flow path 54 of small cross section between the inlet and outlet orifices 48, 50 guaranteeing an optimal cleaning of the first cavity 46 during a change of ink by preventing the formation of dead areas in the first cavity 46. Thus said at least one flow path 54 is configured to pass through the entire first cavity 46.

According to one embodiment which can be seen in FIG. 5, the partition 52 and the casing 42 form one and the same part.

According to a further embodiment, the partition 52 and the casing 42 are two separate elements which are connected in a sealed manner.

The pressure regulating device 40 comprises at least one control system 56 which is configured to control the state of the membrane 44. This control system 56 makes it possible to cause a change of state of the membrane 44 between the first and second states.

According to one embodiment, the pressure regulating device 40 comprises at least one second cavity 58 which is separated from the first cavity 46 by the membrane 44. To this end, the pressure regulating device 40 comprises a cover 60 and at least one fixing element 62 connecting the cover 60 and the casing 42, the cover 60 being configured to delimit with the membrane 44 the second cavity 58. According to one arrangement, the pressure regulating device 40 comprises a plurality of fixing elements 62, such as bolts, screws or rivets for example, connecting the cover 60 and the flange 42.4 of the casing 42. The cover 60 comprises a lower face F60 which is oriented toward the second cavity 58 and an external face F60′ opposing the internal face F60.

According to one embodiment, the second cavity 58 contains a gas and the control system 56 comprises at least one system for controlling the pressure of the gas contained in the second cavity 58 which is configured to adjust the pressure of the gas in the second cavity 58 to a value of less than or equal to a first threshold corresponding to the first state of the membrane 44 or to a value of greater than or equal to a second threshold corresponding to the second state of the membrane 44, the first threshold being less than or equal to the second threshold. In order to provide an order of magnitude, the second threshold is in the order of 0.5 bar in terms of a difference in pressure on either side of the membrane 44. This second threshold is provided by way of example and can vary, in particular, as a function of the material of the membrane 44, the ink pressure, etc.

According to one configuration, the pressure regulating device 40 comprises at least one pressure sensor 64 which is configured to measure the pressure of the gas which is present in the second cavity 58.

According to one embodiment, the pressure regulating device 40 comprises at least one temperature regulating system 66 which is configured to regulate the temperature of the ink which is present in the first cavity 46. According to one configuration, the temperature regulating system 66 comprises at least one heating plate 66.1 which is placed against the external face F42.1′ of the bottom wall 42.1, this wall being produced from a thermally conductive material. By way of example, the bottom wall 42.1 is made of stainless steel or an aluminum alloy.

Integrating the temperature regulating system 66 in the pressure regulating device 40 makes it possible to obtain a more compact ink distribution system 36. Providing one or more partitions 52 makes it possible increase the length of time for the passage of the ink in the pressure regulating device 40 and the heat exchange surface between the casing 42 and the ink, which promotes the thermal transfer between the temperature regulating system 66 and the ink.

According to one embodiment, the pressure regulating device 40 comprises at least one position sensor 68, for example of the capacitive type, which is configured to determine the position of the membrane 44 and more particularly to determine if the membrane 44 occupies the first state or the second state. According to one arrangement, this position sensor 68 is connected to the cover 60 and positioned on the external face F60′ thereof.

According to an advantageous configuration which can be seen in FIG. 4, the ink distribution system 36 comprises at least one pair of first and second pressure regulating devices 40, 40′. Thus when the second ink regulating device 40′ is used to transfer the ink from the ink reservoir 32 to the printing head 34, by regulating the ink pressure (its membrane 44 occupying the first state), the first ink regulating device 40 can be cleaned (its membrane 44 occupying the second state).

According to this configuration, the ink distribution system 36 comprises a substrate 70 which is approximately parallelepipedal and which comprises first and second opposing faces F70, F70′, respectively having first and second recesses 72, 72′, the first recess 72 being configured to receive the casing 42 of the first pressure regulating device 40, the second recess 72′ being configured to receive the casing 42 of the second pressure regulating device 40′. The ink distribution system 36 comprises a first cover 60 which is placed against the first face F70 of the substrate 70 and which is connected thereto so as to capture the casing 42 and the membrane 44 of the first pressure regulating device 40 in the first recess 72, and a second cover 60′ which is placed against the second face F70′ of the substrate 70 and which is connected thereto so as to capture the casing 42 and the membrane 44 of the second pressure regulating device 40′ in the second recess 72′.

According to one embodiment, the substrate 70 comprises a first pipe 74.1 opening in the region of the first recess 72 in line with the inlet orifice 48 of the first pressure regulating device 40, a second pipe 74.2 opening in the region of the first recess 72 in line with the outlet orifice 50 of the first pressure regulating device 40, a third pipe 74.3 opening in the region of the second recess 72′ in line with the inlet orifice 48 of the second pressure regulating device 40′ and a fourth pipe 74.4 opening in the region of the second recess 72′ in line with the outlet orifice 50 of the second pressure regulating device 40′. In addition, the ink distribution system 36 comprises a first annular seal 76.1 interposed between the substrate 70 and the first pressure regulating device 40 in the region of its inlet orifice 48, a second annular seal 76.2 interposed between the substrate 70 and the first pressure regulating device 40 in the region of its outlet orifice 50, a third annular seal 76.3 interposed between the substrate 70 and the second pressure regulating device 40′ in the region of its inlet orifice 48 and a fourth annular seal 76.4 interposed between the substrate 70 and the second pressure regulating device 40′ in the region of its outlet orifice 50.

Naturally the invention is not limited to this embodiment for the distribution system 36. This distribution system can comprise further elements, such as a filter and a degassing cartridge, for example.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An ink pressure regulating device for a printing machine, the ink pressure regulating device comprising:
a rigid casing;
a flexible membrane which is connected to the rigid casing in a sealed manner in order to delimit a first cavity;
an inlet orifice which is configured to permit an ink to penetrate into the first cavity;
an outlet orifice which is configured to permit the ink to exit from the first cavity;
a partition located in the first cavity and which is configured to generate in the first cavity a flow path connecting the inlet orifice and the outlet orifice, wherein the flexible membrane is configured to occupy a first state in which the flexible membrane is at a distance from the partition and a second state in which the flexible membrane is in contact with the partition so as to form the flow path; and
a control system configured to control a state of the flexible membrane.

2. The ink pressure regulating device as claimed in claim 1, wherein the rigid casing comprises a bottom wall and a cylindrical lateral wall which is connected to the bottom wall and which has a free edge at a distance from the bottom wall,
wherein the partition is a spiral-shaped partition connected to the bottom wall, and
wherein the flow path is a spiral-shaped flow path.

3. The ink pressure regulating device as claimed in claim 2, wherein one of the inlet orifice and the outlet orifice adjoins the lateral wall, wherein the other of the inlet orifice and the outlet orifice is located substantially in a center of the bottom wall.

4. The ink pressure regulating device as claimed in claim 1, further comprising:
a temperature regulating system configured to regulate a temperature of ink in the first cavity.

5. The ink pressure regulating device as claimed in claim 4, wherein the rigid casing comprises a bottom wall and a cylindrical lateral wall which is connected to the bottom wall and which has a free edge at a distance from the bottom wall,
wherein the partition is a spiral-shaped partition connected to the bottom wall,
wherein the flow path is a spiral-shaped flow path,
wherein the bottom wall has an internal face which is oriented toward the first cavity and an external face opposing the internal face, and
wherein the temperature regulating system comprises a heating plate placed against the external face of the bottom wall, the bottom wall comprising a thermally conductive material.

6. The ink pressure regulating device as claimed in claim 1, further comprising:
a cover connected to the rigid casing so as to delimit, with the flexible membrane, a second cavity.

7. The ink pressure regulating device as claimed in claim 6, wherein the control system comprises a system for controlling a pressure of a gas present in the second cavity and which is configured to adjust the pressure of the gas in the second cavity to a value of less than or equal to a first threshold corresponding to the first state of the membrane or to a value of greater than or equal to a second threshold corresponding to the second state of the membrane, the first threshold being less than or equal to the second threshold.

8. The ink pressure regulating device as claimed in claim 7, further comprising:
a pressure sensor which is configured to measure the pressure of the gas in the second cavity.

9. The ink pressure regulating device as claimed in claim 1, further comprising:
a position sensor configured to determine a position of the flexible membrane.

10. A printing machine comprising:
an ink reservoir;
a printing head; and
an ink distribution system connecting the ink reservoir and the printing head, the ink distribution system comprising at least one ink pressure regulating device as claimed in claim 1.

11. The printing machine as claimed in claim 10, wherein the at least one ink pressure regulating device comprises a first pressure regulating device and a second pressure regulating device.

12. The printing machine as claimed in claim 11, wherein the ink distribution system further comprises:
a substrate with a first face and a second face opposite the first face, the first face having a first recess and the second face having a second recess;
a first cover placed against the first face of the substrate and which is connected thereto so as to capture the rigid casing and the flexible membrane of the first pressure regulating device in the first recess; and,
a second cover placed against the second face of the substrate and which is connected thereto so as to capture the rigid casing and the flexible membrane of the second pressure regulating device in the second recess.
